(19) United States
(12) Patent Application Publication
(10) Pub. No.: US 2005/0135609 A1
(43) Pub. Date: Jun. 23, 2005

(54) Gigabit Ethernet passive optical network for securely transferring data through exchange of encryption key and data encryption method using the same

(76) Inventors: Hak-Phil Lee, Namdong-gu (KR); Whan-Jin Sung, Suwon-si (KR)

Correspondence Address: CHA & REITER, LLC, 210 ROUTE 4 EAST STE 103, PARAMUS, NJ, 07652, US

(21) Appl. No.: 10/891,653

(22) Filed: Jul. 15, 2004

(30) Foreign Application Priority Data
Dec. 18, 2003 (KR) 2003-93277

(51) Int. Cl. H04K 1/00

(52) U.S. Cl. 380/30

(57) ABSTRACT

A Gigabit Ethernet passive optical network (GE-PON) for securely transferring data through exchange of an encryption key comprises an optical line terminal (OLT) for encrypting a secret key using a public key received through a transmission medium, transmitting the encrypted secret key, encrypting data using the encrypted secret key, and transmitting the encrypted data, and at least one optical network terminal (ONT) for transmitting the public key to the OLT, decrypting the encrypted secret key transmitted from the OLT using a private key, and decrypting the data encrypted with the encrypted secret key, transmitted from the OLT, using the decrypted secret key.

### CLAIM OF PRIORITY

This application claims priority to an application entitled “GIGABIT ETHERNET PASSIVE OPTICAL NETWORK FOR SECURELY TRANSFERRING DATA THROUGH EXCHANGE OF ENCRYPTION KEY AND DATA ENCRYPTION METHOD USING THE SAME,” filed in the Korean Intellectual Property Office on Dec. 18, 2003 and assigned Serial No. 2003-93277, the contents of which are hereby incorporated by reference.

### BACKGROUND OF THE INVENTION

1. Field of the Invention

The present invention relates to a Gigabit Ethernet passive optical network (GE-PON) provided with an optical line terminal (OLT) at the service provider side and a plurality of optical network terminals (ONTs) at the user side, and more particularly to an encryption method for data security between one OLT and a plurality of ONTs.

2. Description of the Related Art

Nowadays, the expansion of public networks, including various wireless networks, very high-speed communication networks, etc., enables mass data to be shared online. Also widespread is the offline sharing of data through low-priced mass storage media, such as compact discs (CDs) or digital versatile discs (DVDs). Therefore, users can be provided with numerous types of data shared online/offline.

This online/offline sharing system is desirable to readily provide a large amount of various data to users, but has a very vulnerable security structure for various types of commercial multimedia data, or data requiring security.

A passive optical network (PON) is a communication network system that transfers signals to end users over an optical cable network. This PON consists of one optical line terminal (OLT) installed in a communication company and a plurality of optical network terminals (ONTs) installed near subscribers, typically a maximum of 32 ONTs connectable to one OLT.

The PON can provide a bandwidth of 622 Mbps in the downstream direction and a bandwidth of 155 Mbps in the upstream direction in one stand-alone system, these bandwidths being allocated among the PON users. The PON may be used as a trunk between a large-scale system, such as a cable TV system, and an Ethernet network for a neighboring building or home employing a coaxial cable.

In the PON, an OLT transmits a signal to an ONT via an optical cable. The ONT, which is a transfer system of the service subscriber side, is an optical network termination unit that provides a service interface to the end user. The ONT receives the signal transmitted from the OLT, processes it in a predetermined manner and then transfers the processed result to an end user. The reverse process is performed by the OLT for the signal received from the subscriber.

The ONT accommodates FTTC (Fiber To The Curb), FTTB (Fiber To The Building), FTTF (Fiber To The Floor), FTTH (Fiber To The Home), FTTO (Fiber To The Office), etc. to afford flexible access to the subscriber. The ONT performs an optical/electrical conversion operation to convert an optical signal from the OLT into an analog electrical signal and transmit the converted electrical signal to the subscriber, and an electrical/optical conversion operation to convert an analog electrical signal from the subscriber into an optical signal and transmit the converted optical signal to the OLT.

FIG. 1 shows a downstream data transmission structure of a Gigabit Ethernet passive optical network, and FIG. 2 shows an upstream data transmission structure of the Gigabit Ethernet passive optical network.

As shown in FIGS. 1 and 2, the structure of the Gigabit Ethernet passive optical network (GE-PON) is such that one OLT 10 is connected via an optical splitter 15 with multiple ONTs 20, 22, 24 in a tree format. The GE-PON is an optical access network more inexpensive and efficient than an AON (Activity-On-Node) network.

As an earlier version of a PON, an asynchronous transfer mode passive optical network (ATM-PON) has been developed and standardized. The ATM-PON transmits ATM cells in the form of a block with a desired size in the upstream or downstream direction. Alternatively, an Ethernet passive optical network (E-PON) transmits packets of different sizes in the form of a block with a desired size. As a result, the E-PON has a somewhat complex control structure compared with the ATM-PON.

In downstream transmission, as shown in FIG. 1, the OLT 10 broadcasts data for reception by the optical splitter 15, which transmits the received data to each of the ONTs 20, 22, 24. Each of the ONTs 20, 22 and 24 detects data to be transferred to a corresponding one of users 30, 32, 34 and transfers that data to the corresponding user.

In upstream transmission, as shown in FIG. 2, data from the users 30, 32, 34 are transferred to the ONTs 20, 22, 24, respectively. The ONTs 20, 22 and 24 transmit the data upstream to the optical splitter 15 according to a transmission permission convention from the OLT 10, respectively. In particular, each of the ONTs 20, 22, 24 transmits received data within a respective time slot set in a TDM (Time Division Multiplexing) manner. Data collision is accordingly avoided in the optical splitter 15.

With the advance of Internet technologies, service subscribers have required data services with greater bandwidths. In this connection, there has been proposed an end-to-end transmission scheme using a Gigabit Ethernet technique that is relatively low in cost and can secure a high bandwidth, as an alternative to an asynchronous transfer mode (ATM) technique that is relatively costly and limited as to bandwidth and that has to segment an Internet protocol (IP) packet. As a result, PON architecture o f the Ethernet, rather than the ATM, type has been required.

Churning using a 24-bit encryption key has been proposed as a packet protocol data unit (PDU) encryption scheme for the ATM-PON. This churning scheme has an encryption capability requiring key value update per second and is a relatively simple algorithm, so it can be used for high-speed support in the ATM-PON with the bit rate of 622 Mbps. Key values being periodically updated are generated in an ONT, inserted in payload fields of operation, administration and maintenance (OAM) cells and then transmitted to an OLT.

DOCSIS (Data Over Cable Service Interface Specification) using a DES-CBC (Data Encryption Standard with Cipher Block Chaining) encryption algorithm has been proposed as another packet PDU encryption scheme.

In the ATM-PON, a 3-byte churning key is inserted in an OAM cell as an encryption key owing to the limitation of encryption techniques and the necessity of high-speed support. In this case, however, there is a limitation in the capability of the encryption key itself. Since the GE-PON utilizes a higher bit rate, e.g., 622 Mbps, than the ATM-PON, it is technically inefficient for the GE-PON to adopt the encryption schemes of the ATM-PON.

In the DOCSIS scheme using the DES-CBC encryption algorithm, the encryption key must be updated every 12 hours so that it can be prevented from being hacked by malicious users. As a result, the application of the DES-CBC encryption algorithm to the GE-PON increases inefficiency of an OLT that must manage a plurality of ONTs in a point to multipoint architecture at a high bit rate.

In addition, since the point to multipoint architecture is relatively vulnerable to corruption or unauthorized intervention, it is an important issue in the GE-PON to encrypt up-link/down-link user data. For this reason, it is necessary to select a powerful and efficient encryption key scheme and effectively operate it. However, the standardizations of encryption and key management scheduling schemes of the GE-PON are merely in progress in IEEE 802.3ah and there is yet to be a determination as to encryption-related packet format.

### SUMMARY OF THE INVENTION

The present invention has been made in view of the above problems, and it is an object of the present invention to provide a Gigabit Ethernet passive optical network for securely transmitting and receiving data between one OLT and a plurality of ONTs, a data encryption method using the same, and a format of an encryption key used therein.

It is another object of the present invention to provide a Gigabit Ethernet passive optical network which is capable of increasing data security in downstream transmission from one OLT to a plurality of ONTs, a data encryption method using the same, and a format of an encryption key used therein.

In accordance with an aspect of the present invention, the above and other objects can be accomplished by the provision of a Gigabit Ethernet passive optical network (GE-PON) comprising: an optical line terminal (OLT) configured for receiving a public key through a transmission medium, using the public key to encrypt a secret key, transmitting the encrypted secret key, using the encrypted secret key to encrypt data, and transmitting the encrypted data. The GE-PON further includes at least one optical network terminal (ONT) configured for transmitting the public key to said OLT; receiving the transmitted, encrypted secret key; using a private key to decrypt the received, encrypted secret key; and using the decrypted secret key to decrypt the encrypted data.

Preferably, the OLT initially transmits, to the ONT, a gate message indicating that the OLT is ready to register the ONT. The gate message includes encryption/decryption information, which is inserted in a desired portion of a reserved field contained in a format of the gate message. The encryption/decryption information includes information about whether encryption is to be performed, and information about an encryption range when the encryption is performed. The encryption range is selected from a group consisting of all data and payload data. The reserved field is 26 bytes long, and the encryption/decryption information is inserted in one byte of the reserved field.

Preferably, the ONT inserts the public key in a data field of a message format and transmits the resulting message to the OLT.

Preferably, the OLT transmits secret key encryption progress information to the ONT during use of the public key to encrypt the secret key. If the encryption of the secret key is completed, the OLT transmits to the ONT encryption completion information and the encrypted secret key. Upon receiving the secret key encryption progress information, the ONT transmits reception acknowledgement information to the OLT.

Preferably, the ONT transmits secret key decryption progress information to the OLT if the encrypted secret key from the OLT is received, and decryption completion information to the OLT if the decryption of the encrypted secret key is completed.

The public key and the private key may be a Rivest-Shamir-Adleman (RSA) public key and an RSA private key, respectively, and the secret key may be an advanced encryption standard (AES) secret key.

In accordance with another aspect of the present invention, there is provided a data encryption method for securely transmitting and receiving data between an OLT and at least one ONT in a GE-PON structure, comprising the steps of: a) the ONT transmitting a public key to said OLT; b) the OLT receiving said public key, using the received public key to encrypt a secret key, and transmitting the encrypted secret key to the ONT; c) the ONT using a private key to decrypt the encrypted secret key transmitted from said OLT; d) the OLT using the secret key to be encrypted to encrypt the data and transmitting the encrypted data to the ONT; and e) the ONT using the decrypted secret key to decrypt the encrypted data.

Preferably, the step b) includes the steps of: b-1) storing the public key transmitted from the ONT; b-2) generating the secret key for the encryption of the data if the public key is stored; and b-3) using the public key to encrypt the secret key.

The data encryption method may further comprise, before step a), the step of the OLT transmitting to the ONT a gate message indicating that the OLT is ready to register the ONT.

Preferably, the gate message includes encryption/decryption information, which is inserted in a desired portion of a reserved field contained in a format of the gate message. The encryption/decryption information includes information about whether encryption is to be performed, and information about an encryption range when the encryption is performed. The encryption range is selected from a group consisting of all data and payload data.

The step b) may further include the steps of: transmitting secret key encryption progress information to the ONT during use of the public key to encrypt the secret key; and, if the encryption of the secret key is completed, transmitting to the ONT encryption completion information and the encrypted secret key.

The step c) may include the step of, upon receiving the secret key encryption progress information, transmitting reception acknowledgement information to the OLT.

The step c) may further include the steps of: transmitting secret key decryption progress information to the OLT if the encrypted secret key from the OLT is received; and transmitting decryption completion information to the OLT if the decryption of the encrypted secret key is completed.

In a feature of the present invention, an OLT encrypts an AES secret key using an RSA public key transmitted from an ONT, transmits the encrypted AES secret key to the ONT, encrypts data using the AES secret key and transmits the encrypted data to the ONT. Therefore, it is possible to efficiently encrypt data in a GE-PON with a point to multipoint architecture. Moreover, the ONT transmits the RSA public key to the OLT to share it with the OLT, and the OLT encrypts the AES secret key for data encryption using the RSA public key and transmits the encrypted AES secret key to the ONT to share it with the ONT. Therefore, it is possible to efficiently encrypt data to be transmitted in the GE-PON with the point to multipoint architecture. Furthermore, in addition to messages which are exchanged for an initial ONT registration procedure described in IEEE 802.3ah EFM, which is an E-PON standard, various messages associated with encryption key exchange (that is, messages associated with encryption ON/OFF, encryption range, public key transfer, encrypted secret key transfer and encryption/decryption progress) are provided which have formats set to enable a secure encryption operation without violating the standard. Therefore, a device can more readily recognize an operating state of a counterpart device or an operation desired thereby by receiving an associated message from the counterpart device.

### BRIEF DESCRIPTION OF THE DRAWINGS

The above features and other advantages of the present invention will be more clearly understood from the following detailed description taken in conjunction with the accompanying drawings, in which the same or similar elements are denoted by identical numerals throughout the several views:

FIG. 1 is a view showing a downstream data transmission structure of a Gigabit Ethernet passive optical network (GE-PON);

FIG. 2 is a view showing an upstream data transmission structure of the GE-PON;

FIG. 3 is a block diagram showing a preferred embodiment of a GE-PON for encrypting data to securely transmit and receive the data between an OLT and an ONT, according to the present invention;

FIG. 4 is a detailed block diagram of an OLT key manager and ONT key manager in FIG. 3;

FIG. 5 is a flow chart illustrating a first embodiment of a data encryption method for securely transferring data between one OLT and a plurality of ONTs in a GE-PON structure, according to the present invention;

FIG. 6 is a flow chart illustrating a second embodiment of the data encryption method according to the present invention; and

FIGS. 7 to 11 are views showing the formats of messages transferred between the OLT and the ONTs in FIG. 6.

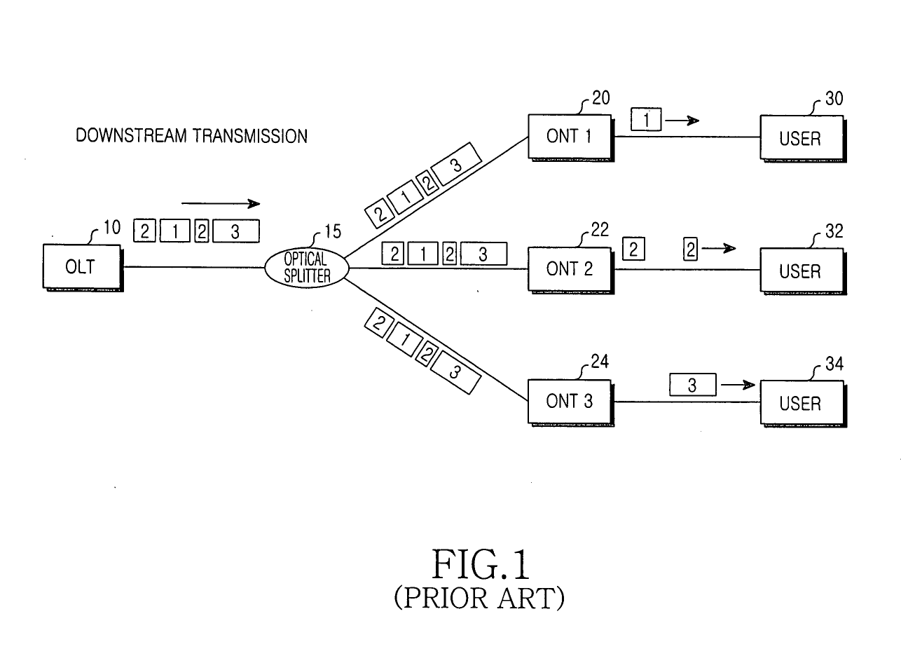

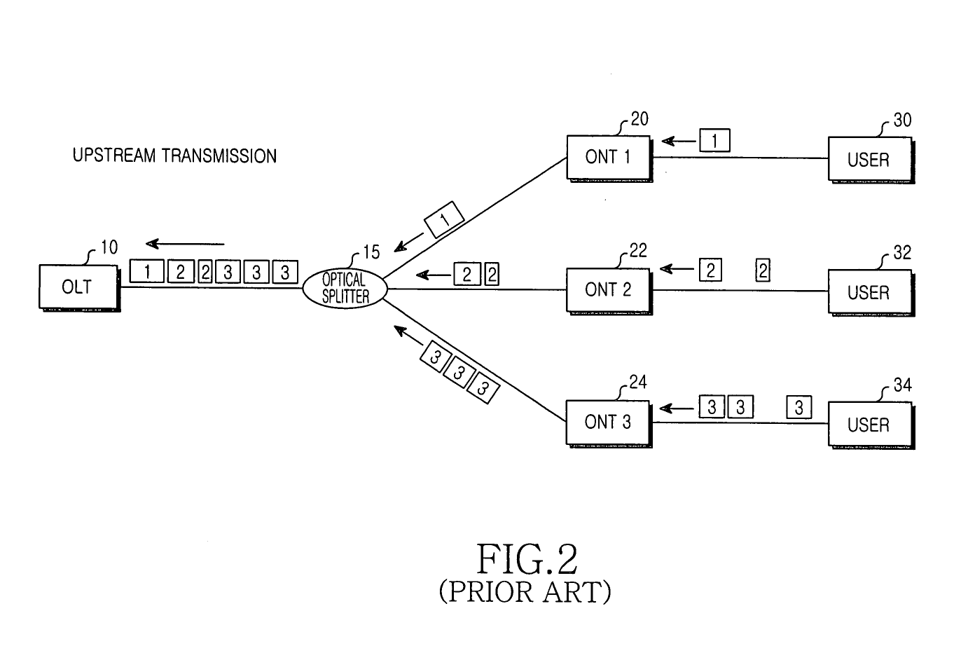

### DETAILED DESCRIPTION

Preferred embodiments of the present invention are described below in detail with reference to the annexed drawings. In the following description, a variety of specific elements such as constituent elements of various concrete circuits are shown. The description of such elements has been made only for a better understanding of the present invention. Those skilled in the art will appreciate that the present invention can be implemented without using the above-mentioned specific elements. In the following description of the present invention, details of known functions and configurations incorporated herein are omitted for clarity of presentation.

A detailed description will hereinafter be given of an example of a data encryption method for securely transmitting and receiving data between one OLT and multiple ONTs in a GE-PON structure, according to the present invention. The data encryption method according to the present invention preferably employs a Rijndael algorithm or advanced encryption standard (AES) secret key algorithm using a 128-bit secret key. This secret key may be encrypted using a Rivest-Shamir-Adleman (RSA) public key algorithm employing a 1024-bit public key and private key so that it can be exchanged online between the OLT and the ONT. References below to a secret key, a public key and a private key may refer, for instance to an AES secret key, an RSA public key and RSA private key, respectively.

Detailed descriptions of the AES secret key algorithm and RSA public key algorithm are shown in references: R. Rivest, A. Shamir and L. Adleman, “A Method for Obtaining Digital Signatures and Public-Key Cryptosystems,” Communications of the ACM, 21(2), pp. 120-126, February 1978, and RSA Laboratories, “PKCS #1 v2.1: RSA Cryptography Standard,” June 2002.

As stated previously, the standard for the initial registration procedure between the OLT and ONT in the GE-PON has already been published, but there is no mention of data encryption for data transmission and reception.

Data encryption using the AES secret key algorithm in the GE-PON, in accordance with the instant invention, is performed with respect to all fields of a GE-PON standard packet format, except for address fields {destination address (DA) and source address (SA) fields}. In addition, in the present invention, the RSA public key algorithm is used to encrypt an AES secret key with an RSA public key. The encrypted AES secret key is inserted in a user data protocol data unit (PDU) field of an Ethernet frame and transmitted to a lower layer.

In an alternative embodiment of the present invention, since data must not be transmitted and received in plaintext form until the exchange of a secret key and public key between the OLT and the ONT is completed, a key exchange procedure for data encryption is incorporated, as a supplement, within the standard GE-PON registration procedure between the OLT and the ONT.

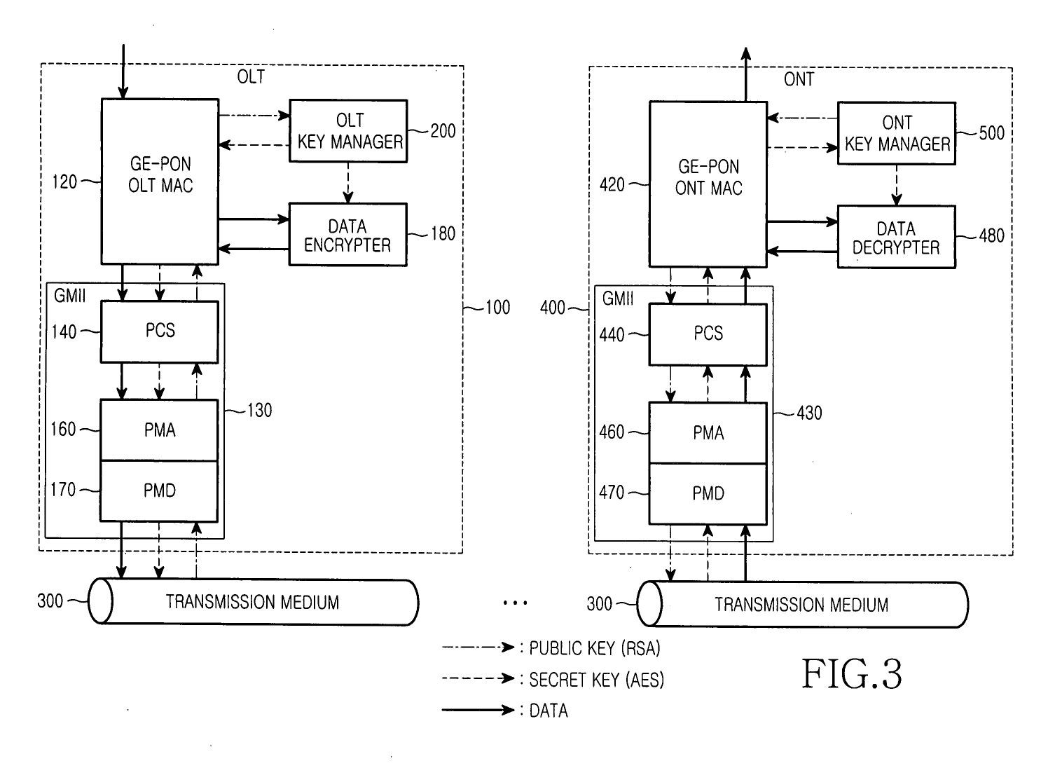

FIG. 3 is a block diagram showing, by way of illustrative and non-limitative example, a preferred embodiment of a GE-PON for encrypting data to securely transmit and receive the data between an OLT and an ONT, according to the present invention. For reference, in the present embodiment, data encryption is processed at a Gigabit Ethernet passive optical network media access control (GE-PON MAC) layer, or data link layer which is layer 2 of the seven layers of the open systems interconnection (OSI) communications model.

As shown in FIG. 3, the GE-PON comprises an OLT 100 and at least one ONT 400 which set up OLT-to-ONT and ONT-to-OLT channels with each other via a transmission medium 300 and transmit and receive data over the set-up channels.

Specifically, the OLT 100 includes a GE-PON OLT MAC module 120, a Gigabit media independent interface (GMII) module 130, an OLT key manager 200, and a data encrypter 180.

The GE-PON OLT MAC module 120 is adapted to support a carrier sense multiple access/collision detect (CSMA/CD) operation for input data at layer 2 of the OSI communications model. The GMII module 130 is adapted to provide an interface between a physical layer, i.e., layer 1 of the OSI communications model, and the MAC layer corresponding to layer 2 of the OSI communications model. This is an extension of a media independent interface (MII) used in a high-speed Ethernet, which supports data processing rates of 10 Mbps, 100 Mbps and 1000 Mbps. The GMII module 130 has an 8-bit independent data transmission/reception path to support both full-duplex and half-duplex.

A GMII layer where the GMII module 130 is located consists of three sub-layers, a physical coding sub-layer (PCS), a physical medium attachment (PMA) sub-layer and a physical medium dependent (PMD) sub-layer. Corresponding modules are provided at the sub-layers, respectively.

A PCS module 140 is provided at the PCS to encode and decode input data on a block-by-block basis. A PMA module 160 is provided at the PMA sub-layer to convert data, inputted from the PCS through the PCS module 140, into serial data, and to convert data inputted from the PMD sub-layer into parallel data, respectively. A PMD module 170 is provided at the PMD sub-layer to convert an electrical signal, i.e., data sent from the PMA sub-layer through the PMA module 160, into an optical signal and send the converted optical signal to the transmission medium 300. The PMD module 170 also acts to convert an optical signal received from the transmission medium 300 into an electrical signal and send the converted electrical signal to the PMA sub-layer.

The OLT key manager 200 is adapted to, upon receiving an RSA public key transmitted from the ONT 400, generate an AES secret key and encrypt the generated AES secret key using the received RSA public key. A copy of this encrypted AES secret key is transmitted, via the GE-PON OLT MAC module 120 and GMII module 130, over the transmission medium 300 to the ONT 400.

The data encrypter 180 is adapted to encrypt plaintext data into ciphertext data using the AES secret key. This encrypted ciphertext data is likewise transmitted, via the GE-PON OLT MAC module 120 and GMII module 130, over the transmission medium 300 to the ONT 400.

The ONT 400 includes a GE-PON ONT MAC module 420, a GMII module 430, an ONT key manager 500, and a data decrypter 480. The GE-PON ONT MAC module 420 and GMII module 430 perform the same functions as those of the GE-PON OLT MAC module 120 and GMII module 130, respectively. The ONT key manager 500 is adapted to store the RSA public key which is used in the OLT 100 for the above-mentioned encryption of the AES secret key, and an RSA private key which is used to decrypt the encrypted AES secret key.

The ONT key manager 500 transmits, via the GE-PON ONT MAC module 420 and GMII module 430, a copy of the stored RSA public key over the transmission medium 30 to the OLT 100 in order to receive a data service from the OLT 100, e.g., the encryption of AES secret key0. Upon receiving the encrypted AES secret key, the ONT key manager 500 decrypts it using the stored RSA private key.

The data decrypter 480 is adapted to, upon receiving from the OLT 100 the ciphertext data encrypted with the AES secret key, decrypt the received ciphertext data using the AES secret key decrypted by the ONT key manager 500.

In summary, the OLT 100 encrypts an AES secret key using an RSA public key transmitted from the ONT 400, transmits the encrypted AES secret key to the ONT 400, encrypts data using the AES secret key and transmits the encrypted data to the ONT 400, thereby making it possible to efficiently encrypt data in the GE-PON with the point to multipoint architecture.

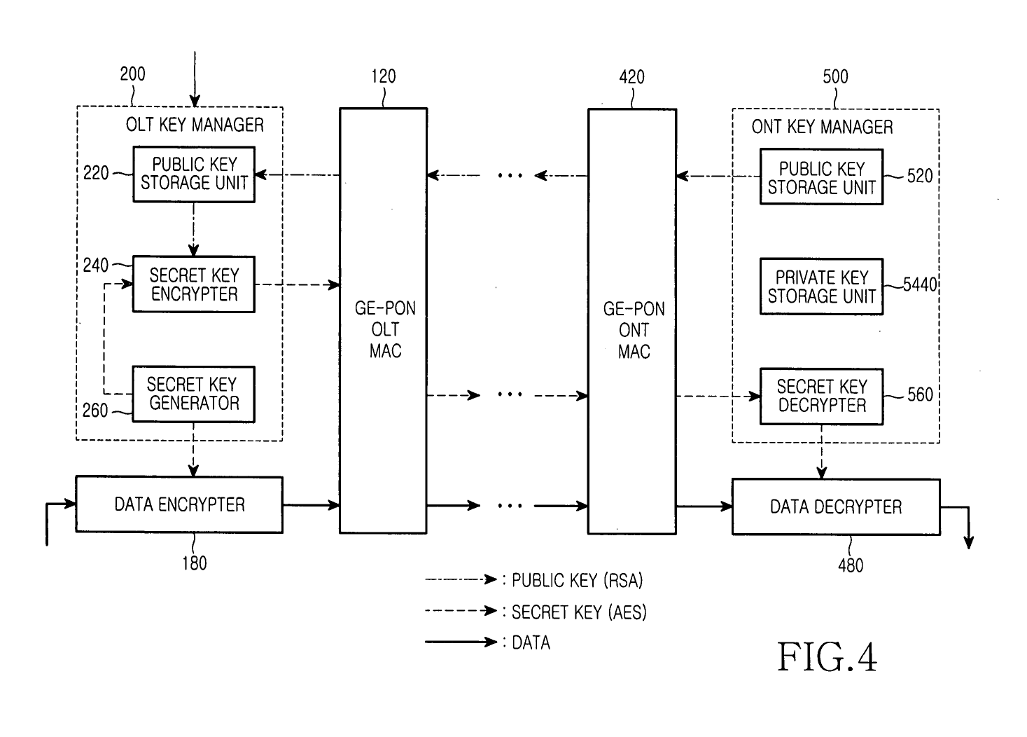

FIG. 4 is a detailed block diagram of the OLT key manager 200 and ONT key manager 500 in FIG. 3. The OLT key manager 200 includes a public key storage unit 220, a secret key encrypter 240 and a secret key generator 260. The public key storage unit 220 stores the RSA public key transmitted from the ONT 400. The secret key generator 260 generates the AES secret key, if the RSA public key is being received from the ONT 400, and provides it to the secret key encrypter 240. The secret key encrypter 240 encrypts the AES secret key using the RSA public key stored in the public key storage unit 220. The secret key encrypter 240 then sends the encrypted AES secret key to the GE-PON OLT MAC module 120. The data encrypter 180 likewise encrypts input data using the AES secret key generated by the secret key generator 260 and sends the encrypted data to the GE-PON OLT MAC module 120.

The ONT key manager 500 includes a public key storage unit 520, a private key storage unit 540 and a secret key decrypter 560. The public key storage unit 520 stores the RSA public key which is used in the OLT 100 for the encryption of the AES secret key. In order to receive a data service from the OLT 100, the ONT key manager 500 transmits the RSA public key stored in the public key storage unit 520 to the GE-PON ONT MAC module 420. The private key storage unit 540 stores the RSA private key which is used for the decryption of the encrypted AES secret key transmitted from the OLT 100. The secret key decrypter 560 uses the stored RSA private key to decrypt the encrypted AES secret key, if the encrypted AES secret key is being received from the OLT 100. The data decrypter 480, upon receiving the encrypted data from the OLT 100, decrypts it using the decrypted AES secret key.

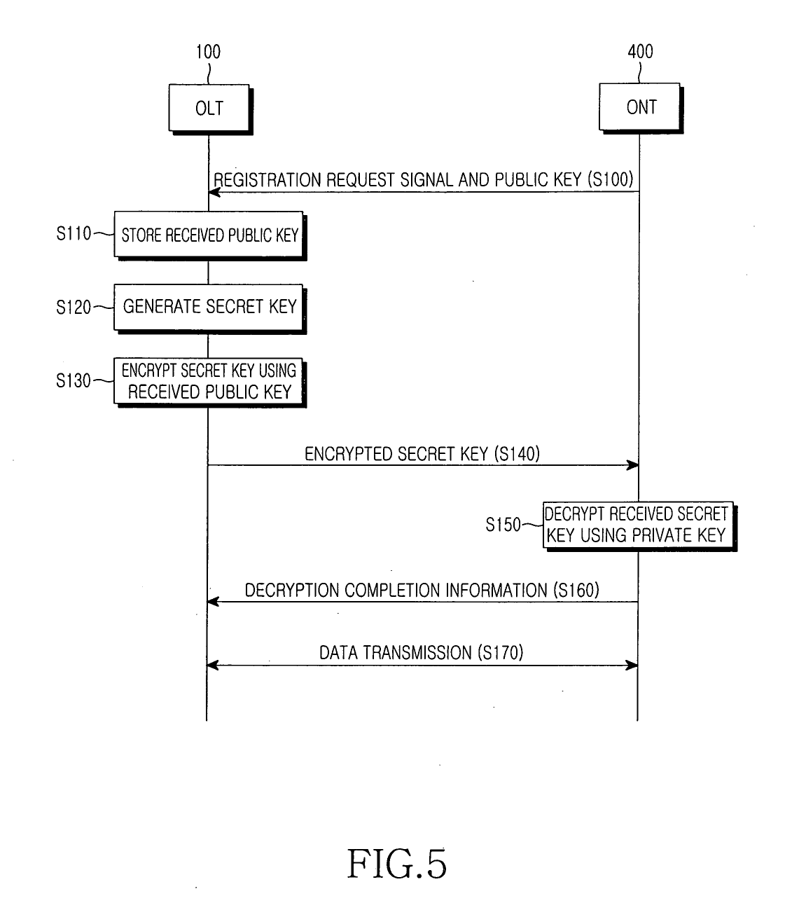

FIG. 5 is a flow chart illustrating a first embodiment of a data encryption method for securely transferring data between one OLT and a plurality of ONTs in a GE-PON structure, according to the present invention.

First, in order to receive a data service from the OLT 100, the ONT 400 sends to the OLT 100 a registration request signal and an RSA public key stored in the public key storage unit 520 (S100). If the OLT 100 receives the registration request signal and RSA public key sent from the ONT 400 and then registers and stores the received RSA public key in the public key storage unit 220 (S110).

If the RSA public key is registered and stored in the public key storage unit 220, the secret key generator 260 generates an AES secret key and provides it to the secret key encrypter 240 (S120). The secret key encrypter 240 uses the RSA public key to encrypt the provided AES secret key (S130). The OLT 100 then sends the encrypted AES secret key to the ONT 400 (S140).

The secret key decrypter 560 of the ONT 400 uses the respective RSA private key to decrypt the encrypted AES secret key and stores the decrypted AES secret key (S150). If the decryption of the AES secret key is completed, the ONT 400 sends decryption completion information to the OLT 100 (S160). If it receives the decryption completion information, the OLT 100 encrypts input data using the generated AES secret key and transmits the encrypted data to the ONT 400, which then acknowledges the data transmission (S170).

In brief, the OLT 100 and the ONT 400 share an RSA public key and AES secret key with each other. The OLT 100 encrypts data using the AES secret key and transmits the encrypted data to the ONT 400. Therefore, it is possible to efficiently encrypt data in the GE-PON with the point to multipoint architecture, and to transmit data with more security.

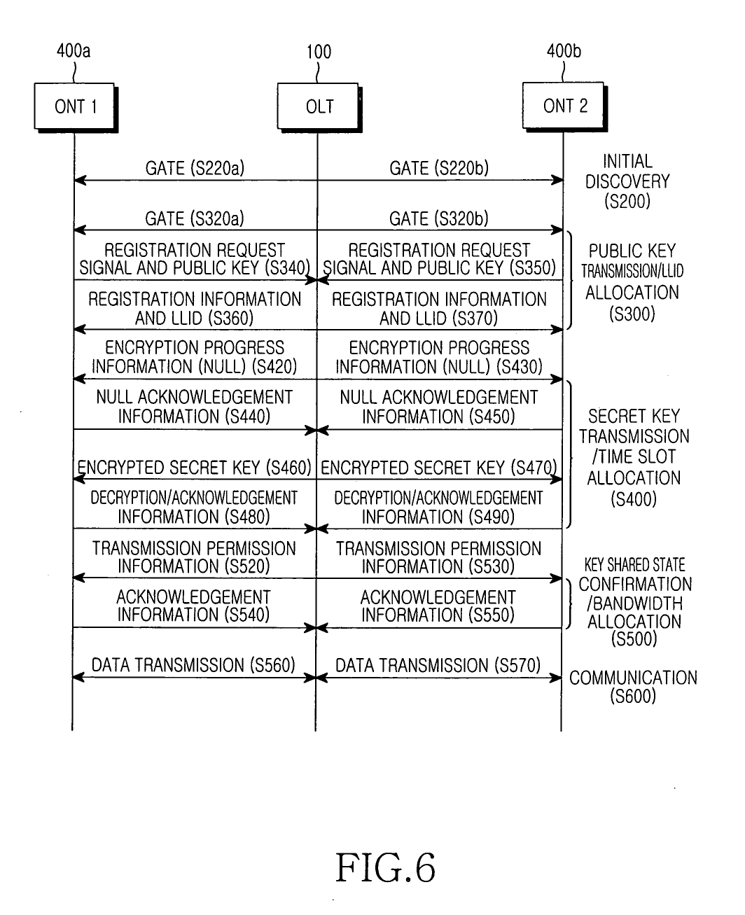

FIG. 6 is a flow chart illustrating a second embodiment of the data encryption method according to the present invention. In this embodiment, the data encryption method is applied to an initial registration step between the OLT 100 and the ONT 400. In FIG. 6, an ONT1 400a and ONT2 400b have the same internal configurations as that of the ONT 400 shown in FIGS. 3 and 4.

The data encryption method according to the present embodiment roughly includes an initial discovery step S200, a public key transmission/LLID (Logical Link IDentification) allocation step S300, a secret key transmission/time slot allocation step S400, a key shared state confirmation/bandwidth allocation step S500 and a communication step S600, which will hereinafter be described in detail.

Upon being powered on and driven, the OLT 100 broadcasts over a communication medium, and to all ONTs connected to it via the medium, a gate signal to discover them (S220a and S220b). In the present embodiment, a description will be given using ONT1 400a and ONT2 400b as examples from among the plural ONTs.

The OLT 100 sends the gate signal to each of ONT1 400a, ONT2 400b at intervals of a predetermined time until it receives back a registration request signal (S320a and S320b). Upon receiving the gate signal, ONT1 400a, ONT2 400b each send the OLT 100 the registration request signal and an RSA public key stored in their respective public key storage units(S340 and S350).

If the OLT 100 receives the registration request signal and RSA public key sent from each of ONT1 400a, ONT2 400b, then it registers each of ONT1 400a, ONT2 400b, registers and stores the RSA public key from each of ONT1 400a, ONT2 400b in the public key storage unit 220 and allocates an LLID to each of ONT1 400a, ONT2 400b. The OLT 100 then sends information about the registrations of ONT1 400a, ONT2 400b and information about the LLIDs allocated thereto to ONT1 400a, ONT2 400b, respectively (S360 and S370).

The OLT 100 also uses the RSA public key received from each of ONT1 400a, ONT2 400b to encrypt a generated AES secret key. It should be noted here that a certain period of time is required to perform such a process. In this regard, during this process, the OLT 100 sends information (encryption progress information or null information) indicating that the encryption of the AES secret key using the RSA public key is in progress to each of ONT1 400a, ONT2 400b (S420, S430). ONT1 400a, ONT2 400b each receive the encryption progress information and send acknowledgement information (null acknowledgement information) to the OLT 100 (S440, S450).

If the encryption of the AES secret key using the RSA public key is completed, the OLT 100 sends the encrypted AES secret key to each of ONT1 400a, ONT2 400b (S460, S470). Upon receiving the encrypted AES secret key from the OLT 100, each of ONT1 400a, ONT2 400b uses the corresponding RSA private key to decrypt the encrypted AES secret key and to send decryption/acknowledgement information to the OLT 100 (S480, S490).

If the OLT 100 receives the decryption/acknowledgement information from each of ONT1 400a, ONT2 400b, then it sends transmission permission information to each of ONT1 400a, ONT2 400b (S520, S530). At this time, the transmission permission information contains information about a bandwidth allocated to a corresponding one of ONT1 400a, ONT2 400b and information about shared states of the RSA public key and AES secret key. ONT1 400a, ONT2 400b each receive the transmission permission information and send acknowledgement information to the OLT 100 (S540, S550).

The OLT 100 and each of ONT1 400a, ONT2 400b, which share the RSA public key and AES secret key in the above manner, transmit data encrypted using the AES secret key to each other (S560, S570).

As described above, in the GE-PON, the OLT 100 and each of the plural ONTs share an RSA public key and an AES secret key in one-to-one correspondence. Even though the OLT 100 encrypts data using a specific AES secret key and sends the encrypted data to the ONTs, only one of the ONTs having the specific AES secret key can decrypt the encrypted data using that key. Therefore, it is possible to efficiently encrypt data in the GE-PON with the point to multipoint architecture.

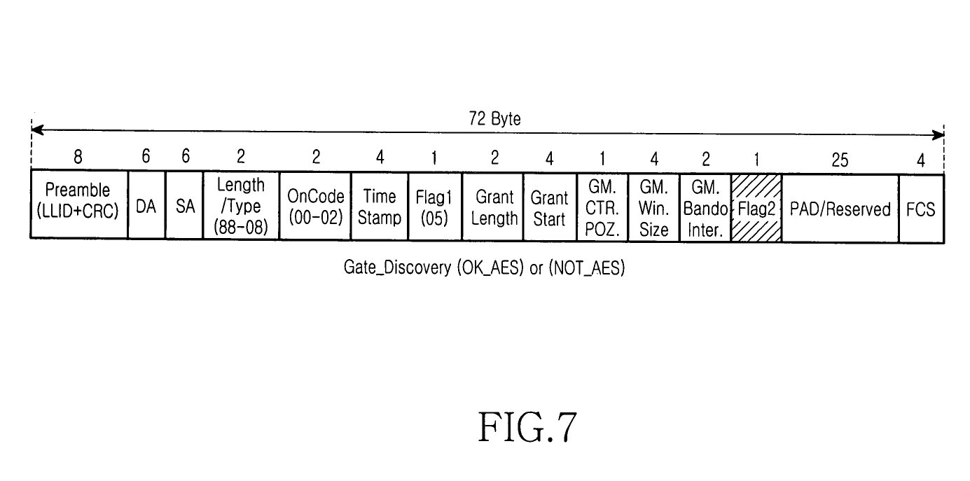

FIGS. 7 to 11 are views showing the formats of messages transferred between the OLT 100 and the ONTs 400a, 400b in FIG. 6.

FIG. 7 shows the format of a gate message that the OLT 100 sends to the ONTs 400a, 400b for their respective initial registrations in steps S220a, S220b, S320a, S320b set forth in FIG. 6.

If the OLT 100 is powered on and its various devices are initialized, it sends a gate message indicating that it is ready to register ONTs 400a, 400b. At this time, for encryption key exchange, the OLT 100 uses one byte, preferably Flag2, of a 26-byte reserved field contained in the existing gate message format. Here, the Flag2 includes promised information specifying whether the OLT 100 encrypts or decrypts and, if it encrypts, a range of encryption, e.g., whether the OLT encrypts all data or only payload. The promised information of the Flag2 can be classified into the following types:
Flag2 is “0x01” (Flag2=0x01), indicating that all data is encrypted;
Flag2 is “0x02” (Flag2=0x02), indicating that only payload is encrypted; and
Flag2 is “0x03” (Flag2=0x03), indicating that no encryption is performed.

Upon receiving this gate message, the ONTs 400a, 400b each can recognize an encryption/decryption operation of the OLT 100 by checking the Flag2 contained in the received message.

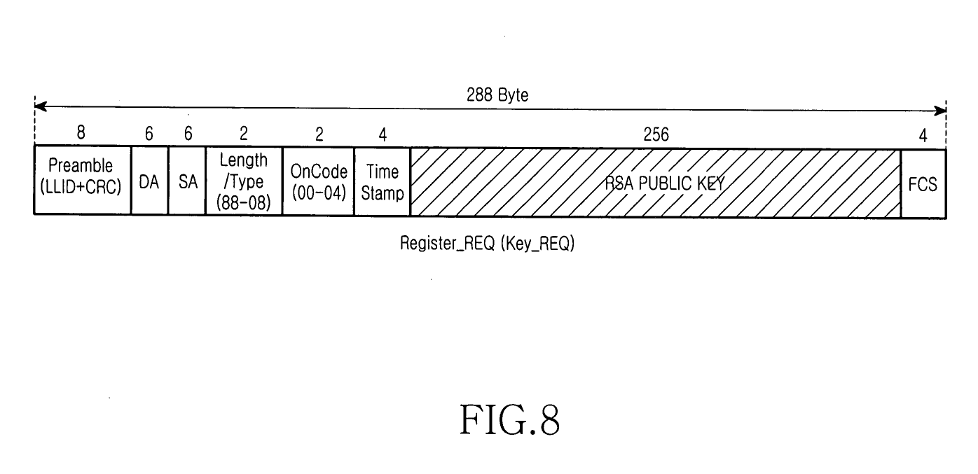

FIG. 8 shows the format of a registration request message that the ONTs 400a, 400b each send to the OLT 100 at steps S340, S350 of FIG. 6.

Since the ONTs 400a, 400b which have received the gate message sent from the OLT 100 are not yet allocated time slots for data transmission from the OLT 100, they each send a registration request message to the OLT after determining a desired delay time. In other words, if ONTs 400a, 400b receive the gate message sent from the OLT 100, then they each read their own RSA public key from their respective public key storage unit 520. Then, the ONTs 400a, 400b each insert the read RSA public key in a data field of the message format along with a registration request signal and send the resulting registration request message to the OLT 100.

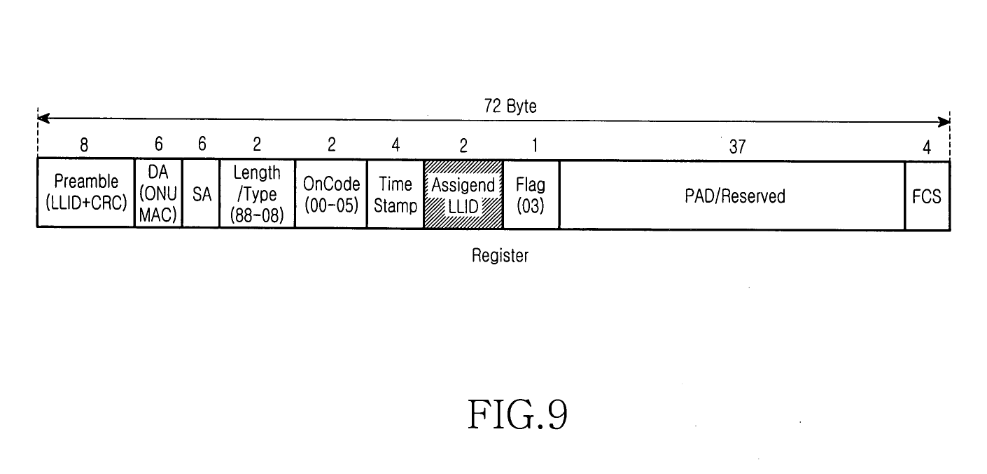

FIG. 9 shows the format of a registration information/LLID message that the OLT 100 sends to the ONTs 400a, 400b at steps S360, S370 of FIG. 6.

If the 0LT 100 receives the registration request signal/public key message from each of ONTs 400a, 400b, then it sends back to each a respective registration information/LLID message containing an LLID allocated to that ONT. Upon receiving the RSA public key sent from each of ONTs 400a, 400b, the OLT 100 generates an AES secret key to be used by the ONTs for encryption. The OLT 100 then uses the RSA public key sent from each of ONTs 400a, 400b to encrypt the respective generated AES secret key.

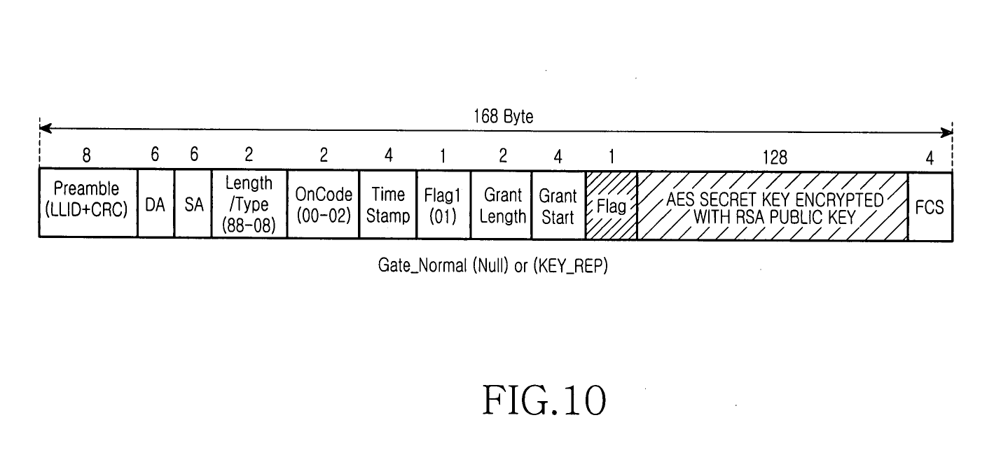

FIG. 10 shows exemplary formats for an encryption progress information (null information) message and encrypted secret key message that the OLT 100 sends to ONTs 400a, 400b in steps S420, S430, S460, S470 of FIG. 6.

During the process of generating the AES secret key and encrypting it using the RSA public key sent from each of ONTs 400a, 400b, the OLT 100 sends an encryption progress information (null information) message to each of ONTs 400a, 400b indicating that the encryption is in progress. When the encryption progress information (null information) message is sent, the OLT 100 is in the process of generating the AES secret key and encrypting it using the RSA public key and each of ONTs 400a, 400b is in a reception standby state to receive the encrypted AES secret key.

Thereafter, if the OLT 100 completes the process of generating the AES secret key and encrypting it using the RSA public key sent from each of ONTs 400a, 400b, the OLT inserts the encrypted AES secret key in a data field of the corresponding message format and sends the resulting message to the respective ONT. When the encrypted AES secret key message is sent, the OLT 100 is in a completed state of the AES secret key generation and encryption. At that time, ONTs 400a, 400b each are in a state of receiving the encrypted AES secret key.

The information inserted in the flag field can be either:
“0x00” (Flag=0x00), indicating that RSA encryption is in progress; or
“0x01” (Flag=0x01), indicating that RSA encryption is completed and that an encrypted AES secret key is contained in a sent message.

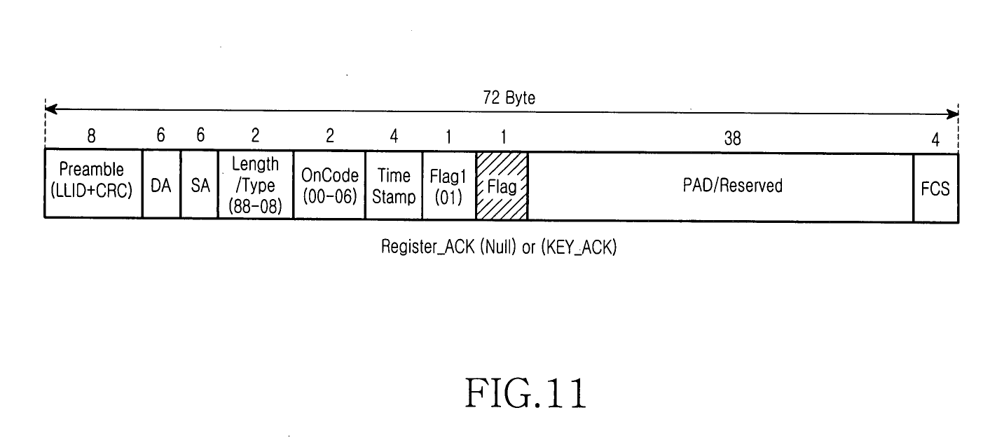

FIG. 11 shows the formats of a null acknowledgement information message and decryption/acknowledgement information message that ONTs 400a, 400b each send to the OLT 100 at steps S440, S450 and steps S480, S490 of FIG. 6.

The null acknowledgement information message is a message indicating that a corresponding one of ONTs 400a, 400b has normally received the encryption progress information (null information) message from the OLT 100. The “null” in the null acknowledgement information message signifies that a corresponding one of ONTs 400a, 400b is in the reception standby state to receive the encrypted AES secret key.

The decryption/acknowledgement information message is a message indicating that a corresponding one of ONTs 400a, 400b has normally received the AES secret key encrypted with the RSA public key from the OLT 100 and has completed the decryption of the encrypted AES secret key using its own RSA private key.

Points of difference between the null acknowledgement information message and the decryption/acknowledgement information message are whether the corresponding ONT is in the reception standby state to receive the encrypted AES secret key and whether the corresponding ONT has received the encrypted AES secret key and completed the decryption thereof. Also, while receiving the encrypted AES secret key and decrypting it with the RSA private key, the ONTs 400a and 400b each can notify the OLT 100 of such a situation by including null information in the corresponding message format of FIG. 11 and sending the resulting message to the OLT 100.

The null acknowledgement information message and the decryption/acknowledgement information message are distinguished from each other according to information inserted in flag fields of the message formats, which can be classified into the following types:
“0x00” (Flag=0x00), indicating that the corresponding ONT is in the reception standby state to receive the encrypted AES secret key or that the corresponding ONT is decrypting the encrypted AES secret key received from the OLT 100 using the RSA private key; or
“0x01” (Flag=0x01), indicating that the corresponding ONT has completed the decryption of the received, encrypted AES secret key using the RSA private key.

As apparent from the above description, according to the present invention, an ONT transmits an RSA public key to an OLT, which then uses the RSA public key to encrypt an AES secret key. The OLT transmits the encrypted AES secret key to the ONT, and likewise uses the AES key to encrypt data for subsequent transmission to the ONT. Therefore, it is possible to efficiently encrypt data in a GE-PON with a point to multipoint architecture.

Moreover, in a GE-PON with a point to multipoint architecture, an OLT shares in one-to-one correspondence with each of a plurality of ONTs an RSA public key and an AES secret key. Even though the OLT encrypts data using a specific AES secret key and sends the encrypted data to the ONTs, only the one of the ONTs having the specific AES secret key can decrypt the encrypted data using that key. Therefore, it is possible to efficiently encrypt data in the GE-PON with the point to multipoint architecture.

Furthermore, in addition to messages which are exchanged for an initial ONT registration procedure described in IEEE 802.3ah EFM, which is an E-PON standard, various messages associated with encryption key exchange (that is, messages associated with encryption ON/OFF, encryption range, public key transfer, encrypted secret key transfer and encryption/decryption progress) are provided which have formats set to enable a secure encryption operation without violating the standard. As a result, a device can more readily recognize an operating state of a counterpart device or an operation desired thereby by receiving an associated message from the counterpart device. Therefore, this invention provides an inevitable base to encryption in an E-PON system which is not yet standardized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A Gigabit Ethernet passive optical network (GE-PON) comprising:
an optical line terminal (OLT) configured for receiving a public key through a transmission medium, using the public key to encrypt a secret key, transmitting the encrypted secret key, using the encrypted secret key to encrypt data, and transmitting the encrypted data; and
at least one optical network terminal (ONT) configured for transmitting said public key to said OLT; receiving the transmitted, encrypted secret key; using a private key to decrypt the received, encrypted secret key; and using the decrypted secret key to decrypt said encrypted data.

2. The GE-PON as set forth in claim 1, wherein said OLT is further configured to initially transmit, to said ONT, a gate message indicating that said OLT is ready to register said ONT.

3. The GE-PON as set forth in claim 2, wherein said gate message includes encryption/decryption information, said information being inserted in a desired portion of a reserved field contained in a format of said gate message.

4. The GE-PON as set forth in claim 3, wherein said encryption/decryption information includes information about whether encryption is to be performed, and, if encryption is to be performed, an encryption range.

5. The GE-PON as set forth in claim 4, wherein said encryption range is selected from a group consisting of all data and payload data.

6. The GE-PON as set forth in claim 5, wherein said reserved field is 26 bytes long, said encryption/decryption information being inserted in one byte of said reserved field.

7. The GE-PON as set forth in claim 1, wherein said ONT is further configured to insert said public key in a data field of a message format and transmit the resulting message to said OLT.

8. The GE-PON as set forth in claim 1, wherein said OLT is further configured to transmit to said ONT, during the encrypting of said secret key, secret key encryption progress information.

9. The GE-PON as set forth in claim 8, wherein said OLT is further configured to transmit to said ONT, if the encryption of said secret key is completed, encryption completion information and said encrypted secret key.

10. The GE-PON as set forth in claim 9, wherein said ONT is further configured to transmit to said OLT, upon receiving said secret key encryption progress information, reception acknowledgement information.

11. The GE-PON as set forth in claim 10, wherein said ONT is further configured to transmit secret key decryption progress information to said OLT if said encrypted secret key from said OLT is received, and decryption completion information to said OLT if the decryption of said encrypted secret key is completed.

12. The GE-PON as set forth in claim 1, wherein said public key and said private key comprise a Rivest-Shamir-Adleman (RSA) public key and an RSA private key, respectively.

13. The GE-PON as set forth in claim 1, wherein said secret key comprises an advanced encryption standard (AES) secret key.

14. A data encryption method for securely transmitting and receiving data between an OLT and at least one ONT in a GE-PON structure, comprising the steps of:
a) said ONT transmitting a public key to said OLT;
b) said OLT receiving said public key, using the received public key to encrypt a secret key, and transmitting the encrypted secret key to said ONT;
c) said ONT using a private key to decrypt said encrypted secret key transmitted from said OLT;
d) said OLT using said secret key to be encrypted to encrypt the data and transmitting the encrypted data to said ONT; and
e) said ONT using the decrypted secret key to decrypt said encrypted data.

15. The data encryption method as set forth in claim 14, wherein said step b) includes the steps of:
b-1) storing said received public key;
b-2) generating said secret key for the encryption of said data if said public key is stored; and
b-3) using the stored public key to encrypt the generated secret key to thereby create said encrypted secret key.

16. The data encryption method as set forth in claim 15, further comprising, before step a), the step of said OLT transmitting to said ONT a gate message indicating that said OLT is ready to register said ONT.

17. The data encryption method as set forth in claim 16, wherein said gate message includes encryption/decryption information, said information being inserted in a desired portion of a reserved field in said gate message.

18. The data encryption method as set forth in claim 17, wherein said encryption/decryption information includes information about whether encryption is to be performed, and, if encryption is to be performed, an encryption range.

19. The data encryption method as set forth in claim 18, wherein said encryption range is selected from a group consisting of all data and payload data.

20. The data encryption method as set forth in claim 15, wherein said step b) further includes the step of transmitting to said ONT, during the encrypting of the generated secret key, secret key encryption progress information.

21. The data encryption method as set forth in claim 20, wherein said step b) further includes the step of, if the encryption of said secret key is completed, transmitting encryption completion information and said encrypted secret key to said ONT.

22. The data encryption method as set forth in claim 21, wherein said step c) includes the step of, upon receiving said secret key encryption progress information, transmitting reception acknowledgement information to said OLT.

23. The data encryption method as set forth in claim 22, wherein said step c) further includes the steps of:
transmitting secret key decryption progress information to said OLT if said encrypted secret key from said OLT is received; and
transmitting decryption completion information to said OLT if the decryption of said encrypted secret key is completed.

24. The data encryption method as set forth in claim 14, wherein step a) includes the step of inserting said public key in a data field of a message format for said transmitting.

25. A data encryption method for securely transmitting and receiving data between an OLT and at least one ONT in a GE-PON structure, comprising the steps of:
a) upon being powered on and driven, said OLT transmitting to all ONTs connected with the OLT a gate signal via a transmission medium to discover the ONTs;
b) said at least one ONT transmitting to said OLT in response to said gate signal a registration request signal and a public key;
c) said OLT, in response to receipt of the transmitted registration request signal, registering said ONT, allocating to said ONT an LLID (Logical Link IDentification) and transmitting to said ONT information about the allocated LLID;
d) said OLT using said public key to encrypt a secret key and transmitting the encrypted secret key to said ONT;
e) said ONT using a private key to decrypt said the transmitted encrypted secret key;
f) said OLT and ONT confirming their sharing of said public key and of said secret key and then allocating a data transmission bandwidth from said OLT to said ONT;
g) said OLT using said secret key to encrypt the data and transmitting the encrypted data to said ONT; and
h) said ONT using the decrypted secret key to decrypt said the transmitted encrypted data.
